(19) United States
(12) Patent Application Publication
(10) Pub. No.: US 2017/0089252 A1
(43) Pub. Date: Mar. 30, 2017

(54) IGNITION PLUGS IN PRECHAMBER AND MAIN COMBUSTION CHAMBER OF AN IC ENGINE

(71) Applicant: Caterpillar Inc., Peoria, IL (US)

(72) Inventors: Andrew Loetz, West Lafayette, IN (US); Joel Hiltner, Ferndale, WA (US)

(73) Assignee: Caterpillar Inc., Peoria, IL (US)

(21) Appl. No.: 14/870,074

(22) Filed: Sep. 30, 2015

(51) Int. Cl. F02B 19/12; F02P 5/00; F02P 15/02; F02B 19/10

(52) U.S. Cl. CPC F02B 19/12; F02B 19/1023; F02P 5/00; F02P 15/02

(57) ABSTRACT

An internal combustion engine having a main combustion chamber, a prechamber, a first ignition plug and a second ignition plug. The main combustion chamber in fluid communication with the prechamber. The first ignition plug disposed in the prechamber for igniting a charge to form a flame jet directed into the main combustion chamber. The second ignition plug disposed in the main combustion chamber for igniting the charge in the main combustion chamber in the path of the flame jet from the prechamber. The second ignition plug configured to ignite the charge in the main combustion chamber prior to the ignition of the charge by the first ignition plug in the prechamber.

### TECHNICAL FIELD

The present disclosure relates to an internal combustion engine. In particular, the present disclosure relates to ignition plugs disposed in a prechamber and a main combustion chamber of an internal combustion engine to prevent lean misfire.

### BACKGROUND

Internal combustion engines often emit oxides of nitrogen (“NOₓ”) during operation. These oxides form when nitrogen and oxygen, both of which are present in the air used for combustion, combine within the main combustion chambers. Typically, the level of NO formed increases as the peak combustion temperatures within the combustion chambers increase. As such, minimizing the peak combustion temperatures within the main combustion chambers generally reduces the emission of NOₓ.

For this reason, leaner fuel mixtures are used for reducing the peak combustion temperatures in the main combustion chamber, thus reducing the amount of NOₓ emitted. A lean fuel mixture has a relatively large air-to-fuel ratio when compared to a stoichiometric air-to-fuel ratio. Accordingly, using more air in the fuel mixture may advantageously lower NOₓ emissions.

Further, most internal combustion engines use an ignition plug to ignite the air/fuel mixture periodically in the engine cycle. However, as the size of the combustion chamber increases, the effectiveness of ignition plugs to induce combustion is diminished. This is due in part because the are generated by the ignition plug is very localized. The situation is exacerbated when the air/fuel ratio is made lean in an effort to reduce emissions and increase fuel efficiency. In a large combustion chamber, for example, it may take an relatively longer period of time for the combustion process to propagate throughout the combustion chamber. Furthermore, using a lean air-to-fuel ratio may result in incomplete combustion i.e. lean misfire within the main combustion chamber. Moreover, turbulence within the main combustion chamber may extinguish the ignition flame before the lean air-fuel mixture combusts. Lean misfire in the engine causes reduced power output and an increase in the amount of un-combusted fuel. In some cases extinguishing of the ignition flame leads to the engine coming to a halt.

To minimize the occurrence of incomplete combustion, some internal combustion engines incorporate a precombustion chamber, or prechamber. Either enriched or non-enriched fuel may be advanced in these prechambers. Ignition of the fuel within the prechamber creates a jet of burning fuel that is directed into the main combustion chamber, thus igniting the lean air-fuel mixture within the main combustion chamber. The jet flame from the prechamber is generally sufficient to cause complete combustion of the lean air-fuel mixture within the main combustion chamber.

U.S. Pat. No. 5,832,892 discloses a main combustion chamber and a sub-combustion chamber to prevent knocking in the engine. Both the main combustion chamber and the sub-combustion chamber have an ignition plug configured to burn the charge present in the respective chambers. The U.S. Pat. No. 5,832,892 patent discloses firing the ignition plug in the main combustion chamber to form a flame front that reaches the inlet opening of the sub-combustion chamber. This inlet opening is opened after the flame front reaches it. The ignition plug in the sub-combustion chamber ignites the charge in the sub-combustion chamber after the flame from the main combustion chamber passes through the inlet opening.

### SUMMARY OF THE INVENTION

In one aspect of the present disclosure, an internal combustion engine is disclosed. The internal combustion engine includes a main combustion chamber, a prechamber, a first ignition plug and a second ignition plug. The main combustion chamber is in fluid communication with the prechamber. The first ignition plug is disposed in the prechamber for igniting a charge to form a flame jet directed into the main combustion chamber. The second ignition plug is disposed in the main combustion chamber for igniting the charge in the main combustion chamber that is in the path of the flame jet from the prechamber. The second ignition plug is configured to ignite the charge in the main combustion chamber prior to the ignition of the charge by the first ignition plug in the prechamber.

In another aspect of the present disclosure, a method of igniting charge in an internal combustion engine is disclosed. The internal combustion engine includes a main combustion chamber and a prechamber. The main combustion chamber is connected to the prechamber. A first ignition plug is disposed in the prechamber and a second ignition plug is disposed in the main combustion chamber. The method includes igniting a charge in the prechamber to form a flame jet directed into the main combustion chamber. Further, the method includes initiating combustion of a charge in the main combustion chamber in the path of the flame jet from the prechamber prior to the ignition of the charge in the prechamber to promote a hotter mixture for the flame jet from the prechamber to ignite.

In yet another aspect of the present disclosure, a method of igniting a charge in an internal combustion engine is disclosed. The engine includes a main combustion chamber connected to a prechamber. A first ignition plug is disposed in the prechamber and a second ignition plug is disposed in the main combustion chamber. The method includes firing the second ignition plug first to heat the charge in the main combustion chamber in the path of a flame jet from the prechamber. Further, the method includes firing the first ignition plug to form a flame jet directed into the main combustion chamber to ignite the heated charge in the main combustion chamber.

### BRIEF DESCRIPTION OF THE DRAWINGS

FIG. 1 illustrates a cross-sectional view of an internal combustion engine according to an embodiment of the present invention, in which an ignition plug is actuated.

FIG. 2 illustrates a cross-sectional view of an internal combustion engine in which another ignition plug is actuated.

FIG. 3 illustrates a cross-sectional view of an internal combustion engine wherein the flame jet is introduced in the main combustion chamber.

FIG. 4 illustrates a cross sectional view of an internal combustion engine according to the another embodiment of the present invention.

FIG. 5 depicts a method of igniting charge within a prechamber and a main combustion chamber according to an embodiment of the present invention.

FIG. 6 depicts a method of igniting charge within a prechamber and a main combustion chamber according to another embodiment of the present invention.

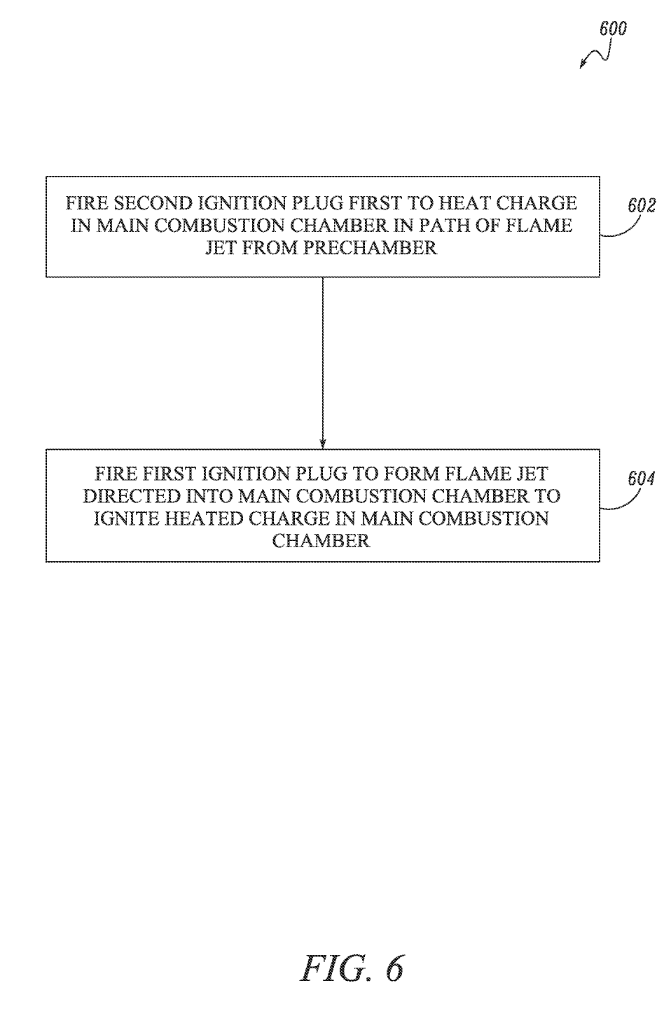

### DETAILED DESCRIPTION

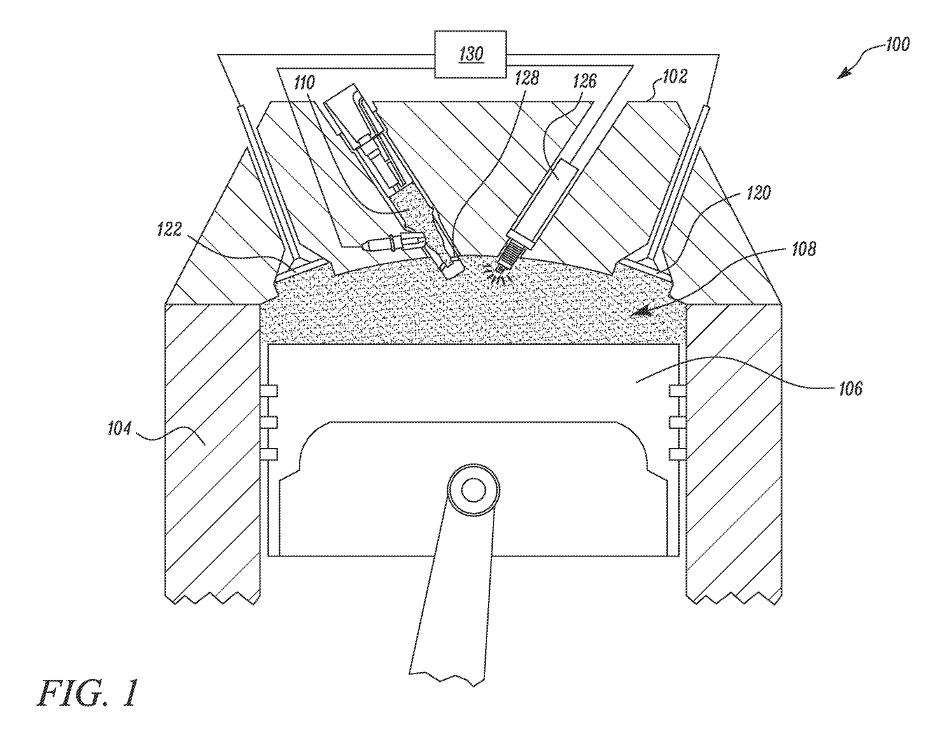

The present disclosure relates to an internal combustion engine for improving the combustion process and avoiding misfire. FIG. 1 illustrates an exemplary engine 100 configure to power any vehicle. In the exemplary embodiment, the engine 100 may be an internal combustion engine for a ground engaging machine. In various other embodiments, the engine 100 may be any engine running on solid, liquid or gaseous fuel, used for various purposes such as an automobile, a construction machine, any transportation vehicle and the like.

Referring to FIG. 1, a first embodiment of an internal combustion engine 100 includes a cylinder head 102 and a cylinder block 104. The cylinder head 102, the cylinder block 104 and a piston 106 form a main combustion chamber 108. The main combustion chamber is configured to receive fuel/air-fuel mixture i.e. charge. The charge is burnt and the piston 106 is configured to transmit the driving force created by the burning charge to an output shaft (not shown).

The main combustion chamber 108 is in fluid communication with a prechamber 110. The prechamber 110 has a capacity that is smaller than that of the main combustion chamber 108. The prechamber 110 is configured to receive either enriched or non-enriched charge. Ignition of the charge within the prechamber 110 creates a jet of burning charge that is directed into the main combustion chamber 108, thus igniting the lean charge within the main combustion chamber 108. In an embodiment, the prechamber 110 may be of spherical shape to promote swirl inside the prechamber 110. As one of skill in the art will appreciate, the prechamber 110 may be of any other type or shape known in the art. In the embodiment illustrated, the prechamber 110 is disposed at substantially a central portion of the main combustion chamber 108. In various other embodiments, the prechamber 110 may be connected with the main combustion chamber 108 at other locations.

A first ignition plug 112 is disposed in the prechamber 110. The first ignition plug 112 may be connected with the prechamber 110 by welding or other methods known in the art. The first ignition plug 112 is disposed at the top of the prechamber 110. In an alternate embodiment, the first ignition plug 112 is disposed at the end of the prechamber 110, near the entrance to the main combustion chamber 108. In various other embodiments the first ignition plug 112 may be disposed at other locations in the prechamber 110. The first ignition plug 112 may be a typical J-gap spark plug, rail plug, extended electrode, or laser plug or any other type of spark plug known in the art.

A charge intake valve 120 may be driven by an intake cam (not shown) and an exhaust valve 122 may be driven by an exhaust cam (not shown), thereby controlling the supply of the charge and the discharge of the combustion products to and from the main combustion chamber.

The main combustion chamber 108 has a second ignition plug 126. The second ignition plug 126 may be disposed proximal to the charge intake valve 120. In an alternate embodiment the second ignition plug 126 may be distal to the charge intake valve 120. The second ignition plug 126 is configured to ignite the charge coming from the charge intake valve 120. The second ignition plug 126 may be connected with the main combustion chamber 108 by welding or other methods known in the art.

The second ignition plug 126 is disposed on the cylinder head 102 of the main combustion chamber 108. In the embodiment illustrated, the second ignition plug 126 is disposed substantially at the center of the main combustion chamber 108. In various other embodiments the second ignition plug 126 may be disposed anywhere on the main combustion chamber 108. The second ignition plug 126 may be a typical J-gap spark plug, rail plug, extended electrode, or laser plug or any other type of spark plug known in the art.

The main combustion chamber 108 and the prechamber 110 are in fluid communication with each other through at least one communication passage 128. The charge that is injected from the charge intake valve 120 is supplied to the main combustion chamber 108 as fresh charge, and is also supplied to the prechamber 110 via the at least one communication passage 128.

The engine 100 has an electronic control unit (ECU) 130. The electronic control unit ECU 130 may be a digital computer that may include a central processing unit (CPU), a read-only-memory (ROM), a random access memory (RAM), and an output interface. The ECU 130 receives input signals from various sensors (not illustrated) that represent various engine operating conditions. For example, an accelerator opening signal from an accelerator opening sensor may detect engine load, a water temperature signal from a water temperature sensor may detect engine temperature, and a crank angle signal from a crank angle sensor may detect the angular position of a crankshaft (not shown), and which may be used by the ECU 130 to calculate engine rotation speed (e.g., number of revolutions per minute of the engine 100). In response to the input signals, the ECU 130 controls various parameters that govern operation of the engine 100. For example, the ECU 130 may control the amount and timing of the charge injected by the charge intake valve 120, the ignition timing of the first ignition plug 112, and the ignition timing of the second ignition plug 126.

In accordance with a given operating condition of the engine 100, the ECU 130 controls a phase difference between the ignition timing of the second ignition plug 126 (i.e., ignition of the charge in the main combustion chamber 108) and the ignition timing of the first ignition plug 112 (i.e., ignition of the charge in the prechamber 110). The ECU 130 controls the actuation of the first ignition plug 112 and the second ignition plug 126 such that the second ignition plug 126 is configured to ignite the charge in the main combustion chamber 108 prior to the ignition of the charge by the first ignition plug 112 in the prechamber 110.

The working of the engine 100 along with the ECU 130 will now be explained in detail with reference to FIG. 1-3. The ECU 130 generates an output signal that causes the charge intake valve 120 to open, thereby allowing enriched or non-enriched charge to advance into the main combustion chamber 108 and the prechamber 110. Referring to FIG. 1, once the charge advances into the main combustion chamber 108 and the prechamber 110, the ECU 130 generates an output signal that causes the second ignition plug 126 to create a spark in the main combustion chamber 108. This causes the charge in the main combustion chamber 108 to initiate combustion. The spark facilitates heating up of the charge in the main combustion chamber 108 thereby enhancing the probability of complete combustion of the unburnt charge in the main combustion chamber 108 using a flame jet from the prechamber 110.

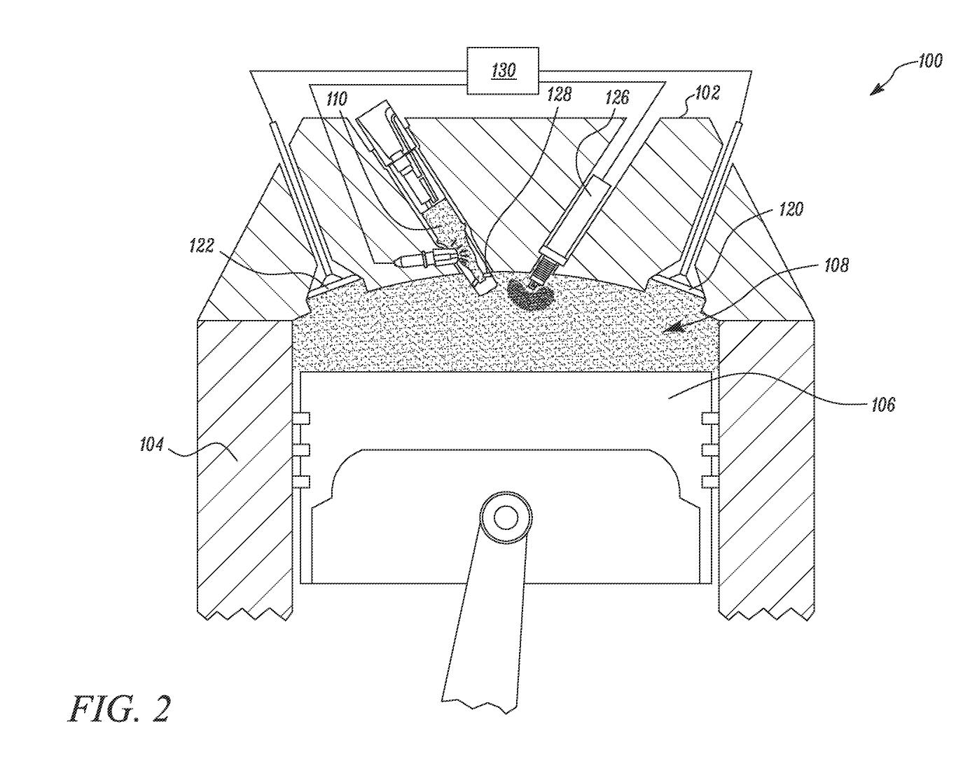

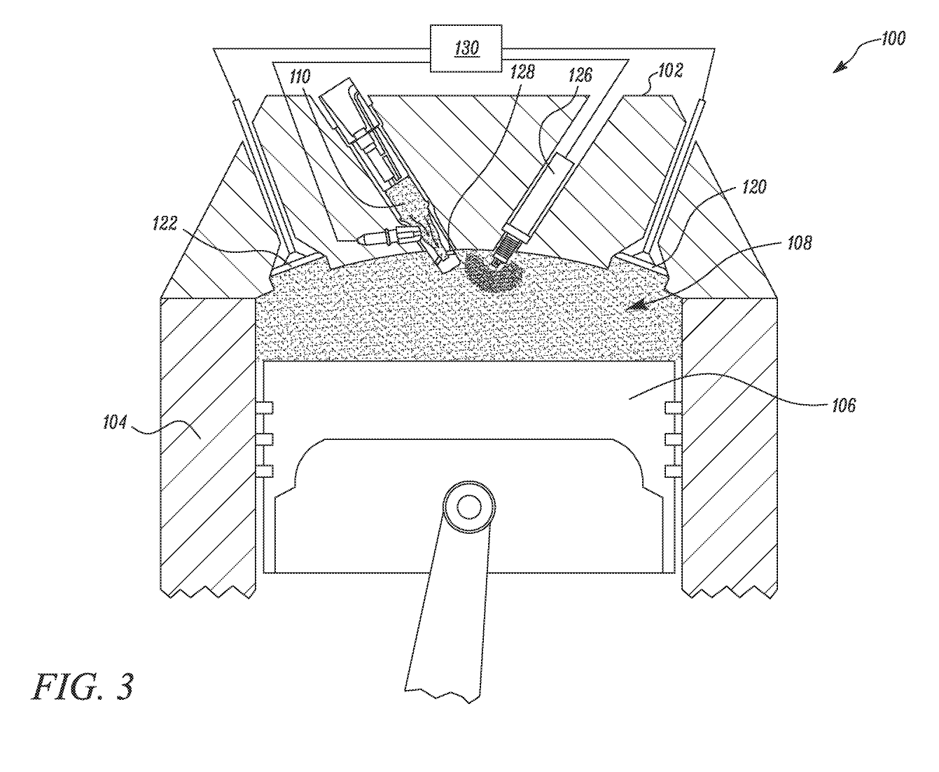

After actuating the second ignition plug 126, the ECU 130 fires the first ignition plug 112 causing an ignition of charge in the prechamber 110 as shown in FIG. 2. The spark from the first ignition plug 112 ignites the charge within the prechamber 110, which causes the flame jet i.e. a front of burning charge through the at least one communication passage 128 and into the main combustion chamber 108 as shown in FIG. 3. The front of burning charge i.e. the flame jet from the prechamber 110 advances through the at least one communication passages 128 and into the main combustion chamber 108 around the second ignition plug 126.

The flame jet entering main combustion chamber 108 ignites the hot charge within main combustion chamber 108, thereby driving the piston 106 downward so as to rotate the crankshaft of the engine 100 for producing mechanical output. Further, the flame jet from the prechamber 110 is propagated through the main combustion chamber 108. The high temperatures around the second ignition plug 126 in the path of the flame jet from the prechamber allows for more robust burning of the flame jet from the prechamber 110.

In an embodiment the difference between firing of the first ignition plug 112 and the second ignition plug 126 may be 5-10 degrees rotation of the crankshaft. In other embodiments, the difference between the firing timings of the first ignition plug 112 and the second ignition plug 126 may be sufficient for the charge in the main combustion chamber 108 to be heated by sparking of the second ignition plug 126 thereby providing a hotter mixture for the flame jet from the prechamber 110 to ignite more robustly.

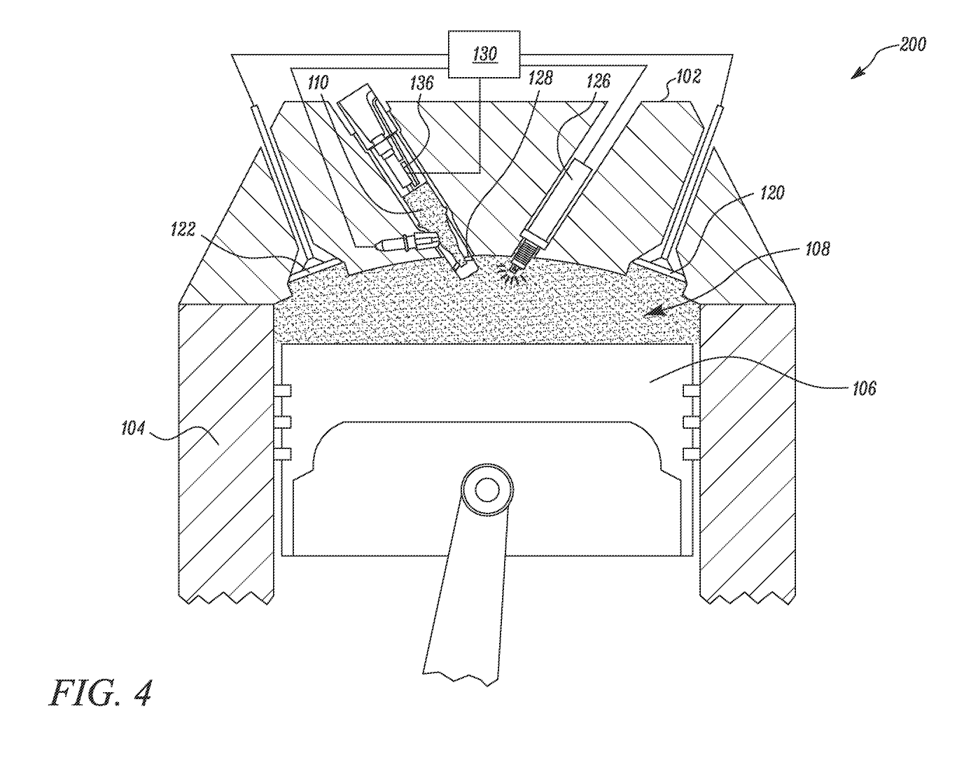

Now referring to FIG. 4, a portion of a second exemplary embodiment of internal combustion engine 200 is provided. In this embodiment, the engine 200 assembly is similar to the engine 100 assembly of FIG. 1. As such, many of the reference numerals used in FIG. 1 are also used in FIG. 4.

One difference between the embodiment of FIG. 4 and the embodiment of FIG. 1, is the presence of a prechamber intake valve 136 in the embodiment of FIG. 4. The prechamber intake valve 136 is configured to allow charge to flow into the prechamber 110 during the intake stroke of piston 106. In the embodiment illustrated, ECU 130 is electrically connected to the prechamber intake valve 136. The ECU 130 may control the amount and timing of the charge injected by the prechamber intake valve 136.

In the embodiment illustrated, the ECU 130 generates an output signal that causes the charge intake valve 120 to position in the open position, thereby allowing enriched or non-enriched charge to advance into the main combustion chamber 108. Further, the ECU 130 may output a control signal, to the prechamber intake valve 136 to be in an open position to introduce fresh charge in the prechamber 110. Once the charge is advanced into the main combustion chamber 108 and the prechamber 110, the ECU 130 generates an output signal to actuate the second ignition plug 126 to create a spark in the main combustion chamber 108. Further, the ECU 130 generates an output signal to actuate the first ignition plug 112 to spark in the prechamber 110 as described in the embodiment above.

### INDUSTRIAL APPLICABILITY

Power producing units such as diesel engines, gasoline engines, and gaseous fuel-powered engines require an optimum amount of air/air-fuel mixture to produce high power at a high efficiency. However, these engines often emit harmful oxides of nitrogen (“NOₓ”) during operation. These oxides form when nitrogen and oxygen, both of which are present in the air used for combustion, combine within the main combustion chambers. Since the level of NOₓ formed increases as the peak combustion temperatures within the combustion chambers increase leaner fuel mixtures are used for reducing the peak combustion temperatures in the main combustion chamber, thus reducing the amount of harmful NOₓ emitted. However, a leaner fuel mixture causes lean misfire inside the engine. This misfiring leads to reduced power output and an increase in the amount of un-combusted fuel. In order to maximize the power output generated by the combustion process in the engine and minimize the occurrence of incomplete combustion, some internal combustion engines incorporate a precombustion chamber, or prechamber. Ignition of the fuel within the prechamber creates a jet of burning fuel that is directed into the main combustion chamber, thus igniting the lean air-fuel mixture within the main combustion chamber. However, a single ignition plug may not be able completely burn the charge present in the prechamber and the main combustion chamber.

In an aspect of the present disclosure, a first ignition plug 112 and a second ignition plug 126 disposed on the prechamber 110 and the main combustion chamber 108 are disclosed and shown in FIG. 1. The ECU 130 configured to control the actuation timings of the first ignition plug 112 and the second ignition plug 126. The ECU 130 generates an output signal to the second ignition plug 126 to create a spark in the main combustion chamber 108. The sparking of the second ignition plug 126 heats the charge present in the main combustion chamber 108 and burns at least some of the charge present around the second ignition plug 126. This creates a high temperature region (shaded area) around the spark plug near the at least one communication passage 128 as shown in FIG. 2.

Further, as shown in FIG. 2, after actuating the second ignition plug 126, the ECU 130 generates an output signal to the first ignition plug 112 to create a spark in the prechamber. This sparking of the first ignition plug 112 ignites the charge within the prechamber 110 and creates a front of burning charge i.e. a flame jet. This flame jet is then passed through the at least one communication passage 128 and into the main combustion chamber 108 near the second ignition plug 126 as illustrated in FIG. 3. The high temperatures around the at least one communication passage 128 allows for more robust burning of the flame jet from the prechamber 110. Further, the flame jet from the prechamber 110 ignites the hot unburnt charge within the main combustion chamber 108 thereby driving the piston 106 downward to produce mechanical output.

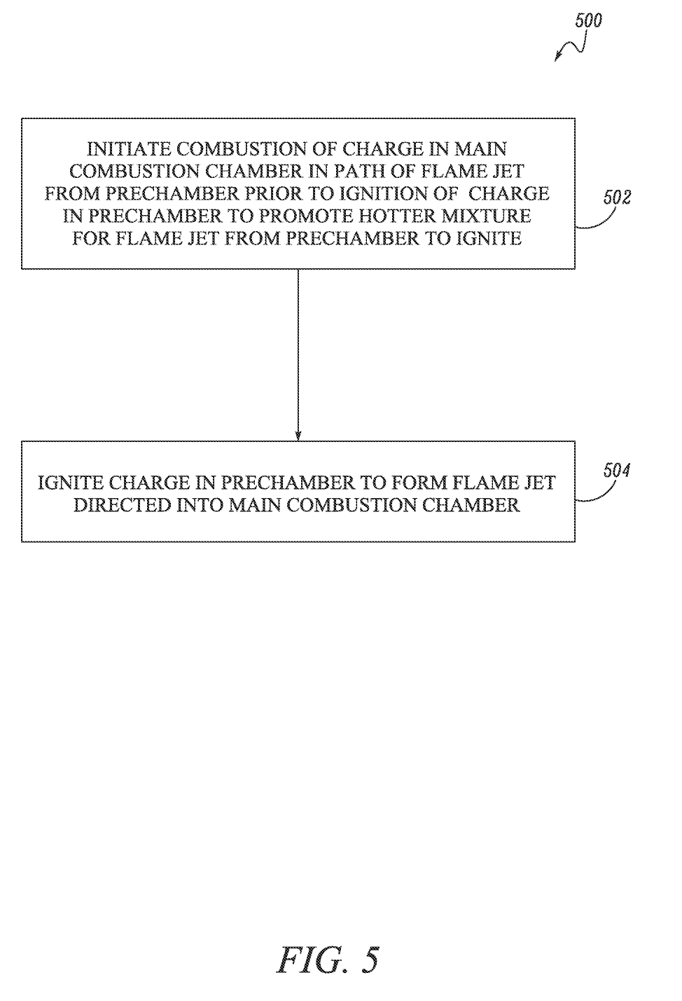

The method 500 of igniting the charge in the internal combustion engine 100 will now be described in detail with reference to FIG. 5. After completion of the compression stroke in the engine 100 the ECU 130 outputs a first control signal to the second ignition plug 126. The second ignition plug 126 is actuated by the first control signal to cause a spark in the main combustion chamber 108 and initiate combustion of the charge in main combustion chamber 108 (Step 502). After the second ignition plug 126 sparks in the main combustion chamber 108 the ECU 130 outputs a second control signal to the first ignition plug 112. The first ignition plug 112 is actuated by the second control signal to cause a spark in the prechamber 110 and ignite the charge present in the prechamber 110 and passes the flame jet to the main combustion chamber 108 (Step 504). The initiation of combustion in the main combustion chamber 108 creates a high temperature area around the second ignition plug 126 which promotes a hotter mixture for the flame jet to ignite. In various other embodiments, the ECU 130 may output control signals to the first ignition plug 112 and the second ignition plug 126 during the compression stroke.

In another aspect of the present disclosure, a method 600 of igniting charge in an internal combustion engine 100 is disclosed. After compressing the charge in the engine 100 the ECU 130 outputs a first control signal to fire the second ignition plug 126. The second ignition plug 126 causes a spark in the main combustion chamber 108 and heats the charge present in the path of flame jet coming from the prechamber (Step 602). After the second ignition plug 126 sparks in the main combustion chamber 108 the ECU 130 outputs a second control signal to fire the first ignition plug 112. The first ignition plug 112 sparks and forms the flame jet which is directed to the main combustion chamber 108. This flame jet ignites the heated charge present in the main combustion chamber 108 (Step 604).

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An internal combustion engine comprising:
a main combustion chamber in fluid communication with a prechamber;
a first ignition plug disposed in the prechamber for igniting a charge to form a flame jet directed into the main combustion chamber; and
a second ignition plug disposed in the main combustion chamber for igniting the charge in the main combustion chamber in the path of the flame jet from the prechamber, the second ignition plug configured to ignite the charge in the main combustion chamber prior to the ignition of the charge by the first ignition plug in the prechamber.

2. The internal combustion engine of claim 1, further comprising a charge valve configured to introduce the charge into the prechamber.

3. The internal combustion engine of claim 1, wherein the second ignition plug is disposed near the center of the main combustion chamber.

4. The internal combustion engine of claim 1, wherein the second ignition plug is proximate to the prechamber.

5. The internal combustion engine of claim 1, further comprising a controller configured to control the firing timings of the first and the second ignition plugs.

6. The internal combustion engine of claim 1, wherein the prechamber is centrally disposed with the main combustion chamber.

7. The internal combustion engine of claim 1 further comprising an electronic control unit configured to actuate the first ignition plug and the second ignition plug.

8. A method of igniting a charge in an internal combustion engine comprising a main combustion chamber connected to a prechamber with a first ignition plug disposed in the prechamber and a second ignition plug disposed in the main combustion chamber; the method comprising:
igniting a charge in the prechamber to form a flame jet directed into the main combustion chamber; and
initiating combustion of a charge in the main combustion chamber in the path of the flame jet from the prechamber prior to the ignition of the charge in the prechamber to promote a hotter mixture for the flame jet from the prechamber to ignite.

9. The method of claim 8 comprising introducing a charge in the main combustion chamber and compressing the charge during a compression stroke of the internal combustion engine prior to igniting the charge.

10. A method of igniting a charge in an internal combustion engine comprising a main combustion chamber connected to a prechamber with a first ignition plug disposed in the prechamber and a second ignition plug disposed in the main combustion chamber; the method comprising:
firing the second ignition plug first to heat the charge in the main combustion chamber in the path of a flame jet from the prechamber; and
firing the first ignition plug to form a flame jet directed into the main combustion chamber to ignite the heated charge in the main combustion chamber.
